(19) United States
(12) Patent Application Publication
(10) Pub. No.: US 2015/0310540 A1
(43) Pub. Date: Oct. 29, 2015

(54) Method and apparatus for real time scheduling of mobile services

(71) Applicant: John Moulton, Orlando, FL (US)

(72) Inventor: John Moulton, Orlando, FL (US)

(21) Appl. No.: 14/545,347

(22) Filed: Apr. 27, 2015

(51) Int. Cl. G06Q 30/06; H04W 4/02; G06Q 30/02

(52) U.S. Cl. CPC G06Q 30/0641; G06Q 30/0253; G06Q 30/0639; H04W 4/023

(57) ABSTRACT

A system and method providing an open marketplace for goods and services brought directly to a user on demand. The system provides a real time interface between buyers and sellers of mobile goods and services. The system comprises a first computer including a first storage media storing a first and second set of executable computer instructions programmed on the first storage media, and a second computer including a second storage media storing a first and second set of executable computer instructions programmed on the second storage media. The first and second executable set of computer instructions provide an open marketplace offering goods and services, and further wherein any user of the system can act as both a buyer and seller, on a real time basis interfacing other users of the system. The availability and location of goods and services is available to users on a real time basis. The system is particularly well adapted to use with smart phones or other portable computer devices.

### CROSS REFERENCE TO RELATED APPLICATIONS

None

### STATEMENT REGARDING FEDERALLY SPONSORED RESEARCH OR DEVELOPMENT

Not Applicable

### THE NAMES OF PARTIES TO A JOINT RESEARCH AGREEMENT

None

### INCORPORATION BY-REFERENCE OF MATERIAL SUBMITTED ON A COMPACT DISK

None

### BACKGROUND OF THE INVENTION

There exists a need for a single system to enable mobile providers and customers the ability to interact on a real time basis. Those selling goods or offering services and those in need of goods or services would benefit from real time communication. Currently, conventional methods of marketing and locating mobile services and goods is complicated and inconvenient. They do not provide an immediate interface between the service/goods providers and the customers.

It has been known for service providers to maintain a calendar or a service log. By proper handling and storage of such information, a schedule or service log can provide a service provider with several benefits, including tracking their activities throughout any given day. Having captured such activity, the individual can make determinations, such as scheduling a particular service, estimating travel time to a given client, and maintaining a record of a given clients past needs. But this system falls well short of providing real time access to mobile goods and services. Additionally, the providers are not in immediate contact with the customers.

Current scheduling systems exist for mobile services, such as conventional trade services including but not limited to such trades as plumbing, or electrical, and such. Scheduling systems for personal services including but not limited to food delivery services, florists, etc. are also well known. Such systems generally incorporate some form of intermediate contact, normally utilizing a human interface between the actual supplier of the service and the customer. In practice, a customer contacts the intermediate human, who then schedules services with the service provider. The system is neither user friendly, because the customer has no immediate contact with the service provider, nor friendly to the service provider, because the intermediate human interface is both slow and an additional operating expense to the service provider.

A vehicle management system is described in U.S. Pat. No. 6,952,645 that utilizes a first communications device, a second communications device, and a data manager. A user at a remote location establishes communication with the first communications device and transmits a vehicle indicator and a location indicator to the first communications device. The vehicle indicator identifies a particular vehicle, and the location indicator identifies a location along the vehicle's route of travel. The first communications device transmits the vehicle indicator and the location indicator to the data manager, and the data manager retrieves location data based on the location indicator. The data manager then correlates and compares the location data with travel data associated with the vehicle. The travel data indicates the current location of the vehicle, and the data manager transmits a message to the user via the second communications device, when the data manager determines that the vehicle is a predetermined proximity from the location identified by the location indicator. No provisions are made for scheduling services are described, however. There is no direct contact between a service provider and a customer, as in the instant invention.

Systems are known that monitor the position and movements of individuals, as seen in U.S. Pat. No. 8,831,627. Employers use devices to monitor employees against diversion from work-related locations, and such devices may be installed in work vehicles, attached to accessories such as computers, or comprise other GPS enabled devices. In addition, an individual must often carry a body-worn device to permit position monitoring. The monitoring of individuals may take either active or passive forms. An active system will compare its location with ongoing restrictions to detect violations. Such a violation may occur by either coming into broadcast range of a prohibited zone, leaving broadcast range of a confinement zone, or by actual location determination and mapping against both permitted and exclusion zones. Alternatively, passive devices may simply record and transmit location information for later or real time comparison with permitted and excluded zones at a remote system.

Many devices have been proposed and employed for such uses. Among the most common are multi-component systems. Such systems typically include a wearable radio frequency (RF) bracelet that communicates with some type of base device. This may be a fixed base system with access to a telephone line that places a telephone call to a monitoring service anytime the RF signal is not detected. Alternatively, it may be a portable base equipped with GPS location technology that detects the presence of the bracelet RF signal and also tracks movements and periodically communicates, typically through wireless phone technology, to report those locations. These devices may also have the capability of displaying text messages from the monitoring entity on an LCD screen. Some base attachments have attempted to utilize voice recognition technology to provide verification of the identity of a person present and responding to a phone call placed through the base unit.

Generally absent from these systems is the ability for real time or near real time communication directly between a remote system and the locator device associated with the individual. In addition, the component costs of custom devices is unnecessarily high compared to the prices available for mass market cellular telephone and GPS technology. Many systems require dedicated phone lines, require the monitored individual to wear or carry obtrusive hardware, require additional hardware for monitoring personnel, lack adequate battery life for multi-day usage, are subject to drift due to GPS signal errors, and lack a method for confirming receipt of messages sent between monitoring personnel and a monitored individual.

Accordingly, there is a need for a tracking system that can be deployed with software capable of running on a wide variety of devices and is therefore largely device agnostic.

There is also a need for an individual tracking system that does not require the use of dedicated phone lines or obtrusive hardware. There is also a need to provide real time or active tracking and active notification to monitoring personnel. Unlike the present invention, these individual tracking devices do not afford service scheduling.

Published United States Patent Application No. 2003/30227382 describes a system that uses biometric information to validate drivers of vehicles containing hazardous cargo to minimize terrorist activities involving these materials. This data needs to be available remotely especially if there is a sudden change in drivers. Similarly, any deviation from the authorized route can be detected and this also needs to be remotely reported. The system provides a central monitoring location at all times. Homeland security issues arising out the components that make up cargo transportation systems including tractors, trailers, chassis, containers and railroad cars, will only be eliminated when the contents of all such elements are known, monitored, and thus the misappropriation of such assets eliminated. The shipping system or process that takes place in the United States should guarantee that all shipping containers contain only the appropriate contents and are always on the proper route from their source to their destination and on schedule. This invention is concerned with achieving this 100 percent system primarily through low power remote monitoring of the assets that make up the shipping system.

The system described in United States Patent Application No. 2003/30227382 for monitoring shipping assets and the contents of shipping containers can also be used for a variety of other asset monitoring problems including the monitoring of unattended boats, cabins, summer homes, private airplanes, sheds, warehouses, storage facilities and other remote unattended facilities. With additional sensors, the quality of the environment, the integrity of structures, the presence of unwanted contaminants etc. can also now be monitored and reported on an exception basis through a low power, essentially maintenance-free monitoring and reporting system in accordance with the invention as described herein. However, no provision is made whereby real-time scheduling is combined with mobile monitoring of vehicles or individuals.

### BRIEF SUMMARY OF THE INVENTION

The SPUR system is an open mobile marketplace for goods and services brought directly to the user on demand. Nearby mobile venders of goods and services can be viewed in real-time. Both the geographic positions of mobile venders and their availability to provide services can be tracked in real-time. Unlike prior systems, the SPUR system is usable by both the vender and the customer. That is, the same system can be used to market and order goods and services. A particular advantage of the SPUR system is the ability to schedule services or the delivery of goods based on the real time geographic location of the vender or customer

### BRIEF DESCRIPTION OF THE DRAWINGS

FIG. 1 shows the homepage for the SPUR system.

FIG. 2 shows the SPUR system in buyer mode.

FIG. 3 shows the SPUR system in a food category.

FIG. 4 shows the SPUR system set for a particular geographic radius from the user.

FIG. 5 represents the user's screen when a search has been performed using various filters.

FIG. 6 shows the SPUR system set for seller mode.

FIG. 7 shows the user's available goods and services.

FIG. 8 shows the user's screen when the SPUR system is set to receive customer requests.

FIG. 9 shows open SPURS in real time.

FIG. 10 shows the SPUR logout screen where business information is stored.

FIG. 11 shows the set of SPURS for the vender.

### DETAILED DESCRIPTION OF THE INVENTION

The SPUR system provides an open marketplace for goods and services brought directly to a user on demand. The system comprises a first computer device with a display including a first storage media for storing a first executable set of computer instructions programmed on the first storage media. Also, the system includes a second computer device with a display including a second storage media storing a second executable set of computer instructions programmed on the second storage media. The the first and second executable set of computer instructions provides an open marketplace whereby a vendor offering goods and services, can interface with a buyer or customer on a real time basis, and further wherein any user of the system can act as both a buyer and seller, on a real time basis to other users of the system.

Advantageously a single computer device supports both mobile vendors and buyers. In this manner, a single system serves both classes of users, that is either buyers or vendors.

The particular computer device is not critical to the practice of the invention. As way of example only, the first computer device comprises smart phones, pad devices, or lap-top computers. Most convenient for the marketing of mobile goods and services is the pad device, or particularly convenient is the smart phone. It should be appreciated that any computer device with a display and internet capability is a perfectly acceptable computer device.

A second computer device could comprise any computer device with a display and internet capability. Phones, pad devices, or lap-top computers are particularly well adapted to the practice of the invention. With internet access and a display users of the system can advertise goods and services including availability and location of the goods and services on a real time basis.

Conveniently the system includes a set of color coded icons indicating the relative availability of a vendor which are displayed to the customer. Users of the system can advertise goods and services and display the location of the goods and services on a real time basis. It is expressly understood that any icon set can be advantageously selected to represent location and availability of goods and services is considered within the scope of the invention. For instance, by way of example only, the real time location of goods or services could be displayed on a map of the locality.

When using the SPUR system the user can toggle between a buyer mode and a seller mode at anytime using a toggle switch. In this manner, the same system is used by both customers and vendors. Indeed, a vendor can switch to the customer mode and purchase goods or services, mid switch back to vendor mode and offer goods and services.

The first computer device stores computer executable instructions, and includes a display, for providing a real time interactive interface between mobile vendors of mobile goods and services and customers for goods and services, on demand. The first computer device including a first storage media storing a first executable set of computer instructions programmed on the first storage media, wherein the first set of executable instructions allows a mobile vendor to offer goods or services to a customer on a real time basis. The first computer device including a first storage media stores a second executable set of computer instructions programmed on the first storage media wherein the second set of executable instructions allows a customer to schedule goods and services on a real time basis, and also allows a vendor to offer goods and services on a real time basis. The SPUR system includes a switch whereby a user of the first computer can alternate the display of the first computer device between a vendor mode or a customer mode. Users of the system in vendor mode can advertise goods and services including availability of the goods and services on a real time basis.

The SPUR system introduces a novel method of interfacing vendors with customers on a real time basis. The method comprises storing computer executable instructions on a first programmable computer device, for providing an on demand real time interactive interface between mobile vendors of mobile goods and services and customers for goods and services. The first executable set of computer instructions programmed on the first computer device enables a mobile vendor to offer goods or services to a customer on a real time basis, in a vendor mode. A second executable set of computer instructions programmed on the first computer device enables a customer to schedule receipt of goods or services from a mobile vendor on a real time basis in a customer mode A user of the SPUR system selects either the vendor mode or the customer mode. In customer mode the user then schedules delivery of goods or services. When in vendor mode the user schedules the delivery of goods or services.

### DETAILED DESCRIPTION OF THE FIGURES

The invention is best described in relation to the various figures. The figures show the SPUR system as it appears on the typical face of a smart phone or tablet screen.

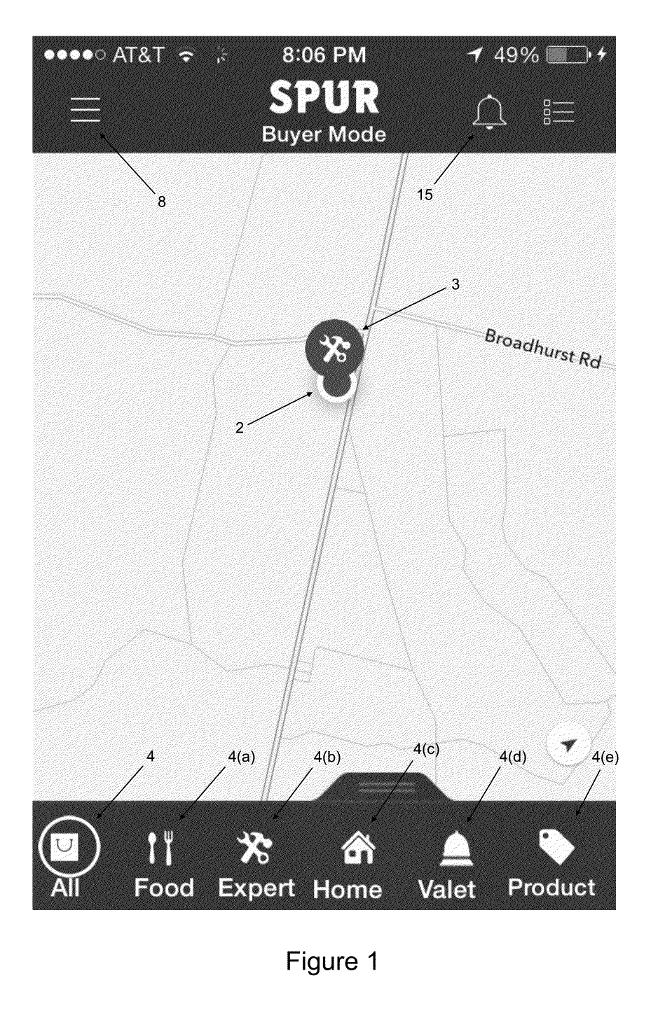

Referring to FIG. 1, the SPUR system home page is seen. One distinct advantage of the SPUR system is the user's ability to simultaneously interact with the system as either a buyer or a seller. The user is able to toggle between two modes, the buyer mode and the seller mode at any time, using a toggle switch typical of touch screens. The system toggle (1) is set to buyer mode in FIG. 1. When in the buyer mode the system also shows the buyer's real-time location (2) as a function of the buyer's GPS. Location (2) is conveniently superimposed on a local map. Associated with the user's location (2) is the selection of products and services (3) that the user has set the system to track on a real-time basis. Along the base of the screen the user can select the products or services of interest, by selecting (4), for all, or one of the subsets of (4), 4(a) for food, 4(b) for expert services, 4(c) for home services, 4(d) for valet services, and 4(e) for products. Selection (3) in FIG. 1 shows that that the user has selected food 4(a), expert services 4(b), home services 4(c), and valet services 4(d). At any time, the user can change the product/service selection, whereby selection (3) will be updated accordingly.

Icon (15), as seen in the various figures, toggles to open the set of SPURS in either buyer or seller mode. In buyer mode, all transaction requests by the buyer will be shown. In seller mode, icon (15) will open the set of customer inquiries.

Although goods and specific services are shown in FIG. 1, it is expressly understood that any combination of goods and services are contemplated.

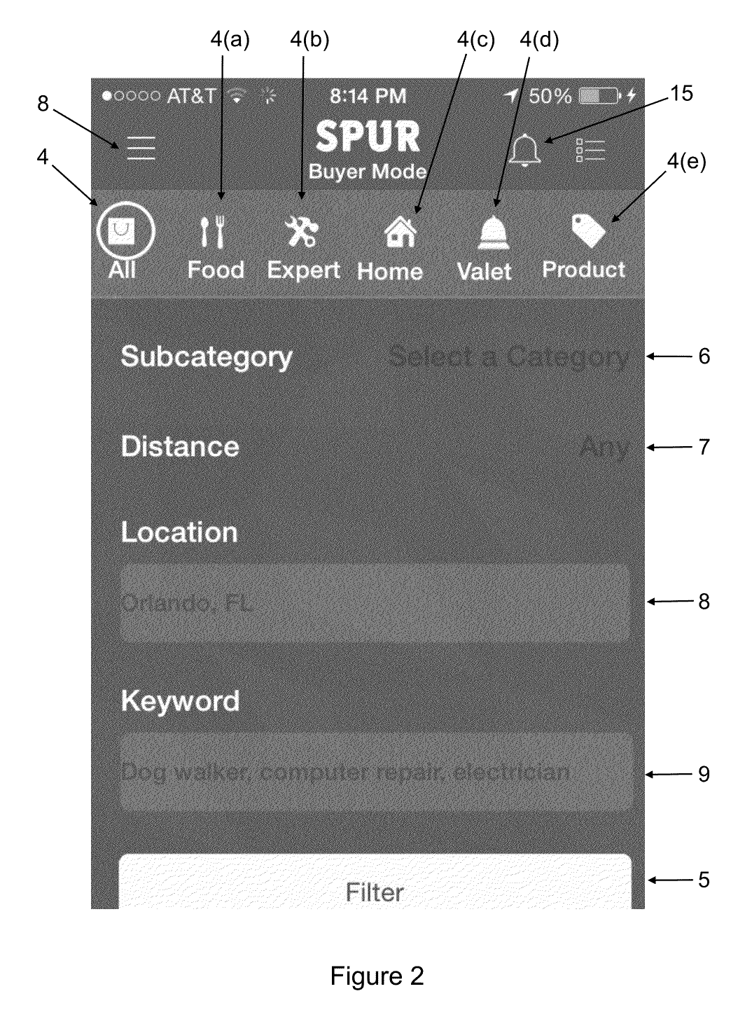

FIG. 2 shows the SPUR system in buyer mode where filter (5) additionally narrows the user's selection of products and services. Selection of specific categories 4(a) through 4(e) allows more specific subcategories to be selected from toggle (6). Toggle (6) enables the user to further filter of the categories to subcategories. The user can select the distance of mobile providers under consideration, by setting a maximum distance of mobile providers under consideration with filter (7). Further, the user can set the system to scan for mobile providers in a given location, such as a city or state, with filter (8). Keywords can be entered with filter (9). It is to be understood that these are merely examples of filters that can be employed and the invention is not to be limited by these examples.

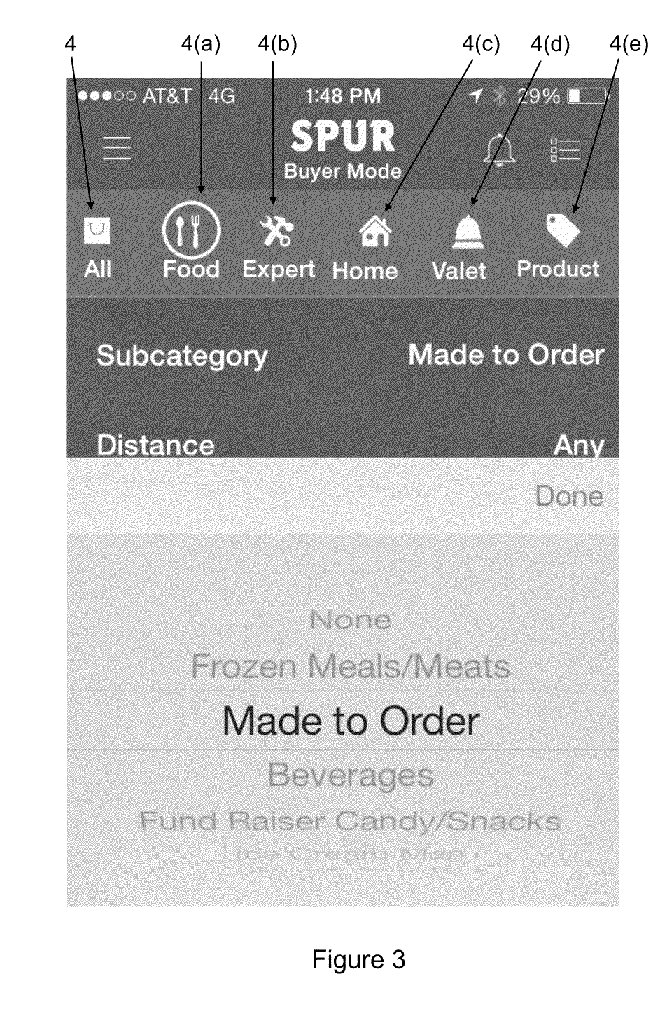

FIG. 3 shows the food category 4(a) further limited to the subcategory (6) made to order, with the distance from the mobile seller unlimited.

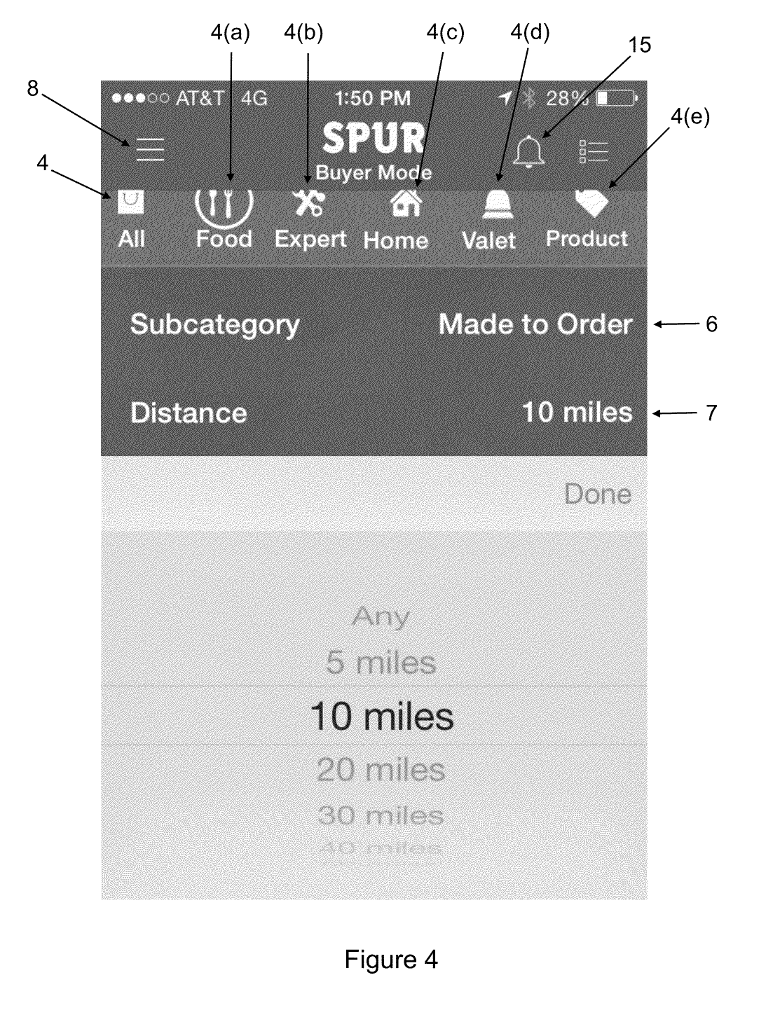

FIG. 4 depicts the user's screen when the distance (7) to subcategory (6) made to order sellers is set at ten miles, i.e. sellers outside the ten mile radius of the user's GPS will be filtered out from the user's choices of sellers.

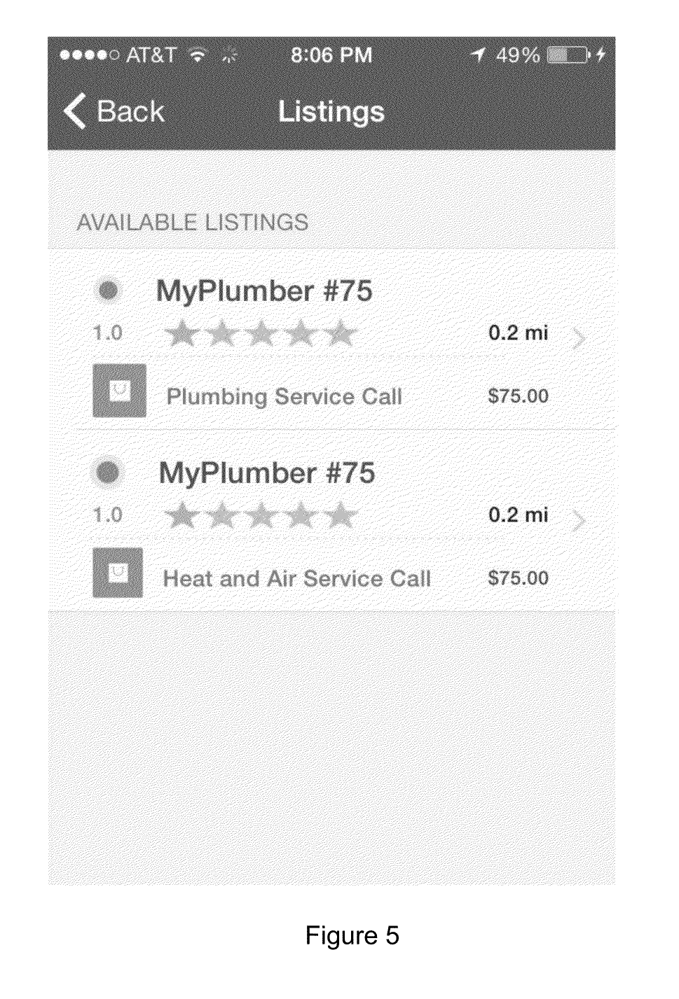

FIG. 5 represents the user's screen when a search has been performed according to the various filters. The system is in buyer mode, set for expert services (4a), food (4b), and products (4e). The food category has been limited by the use of a filter to limit the foods to those that are made to order; the expert services category has been limited to plumbers; and the product category has been limited to automobiles. The seller's fee structure is seen on the right of the screen, as flat, or hourly. Zero mileage is indicated as a default when the user has set no mileage constraints through use of a mileage filter.

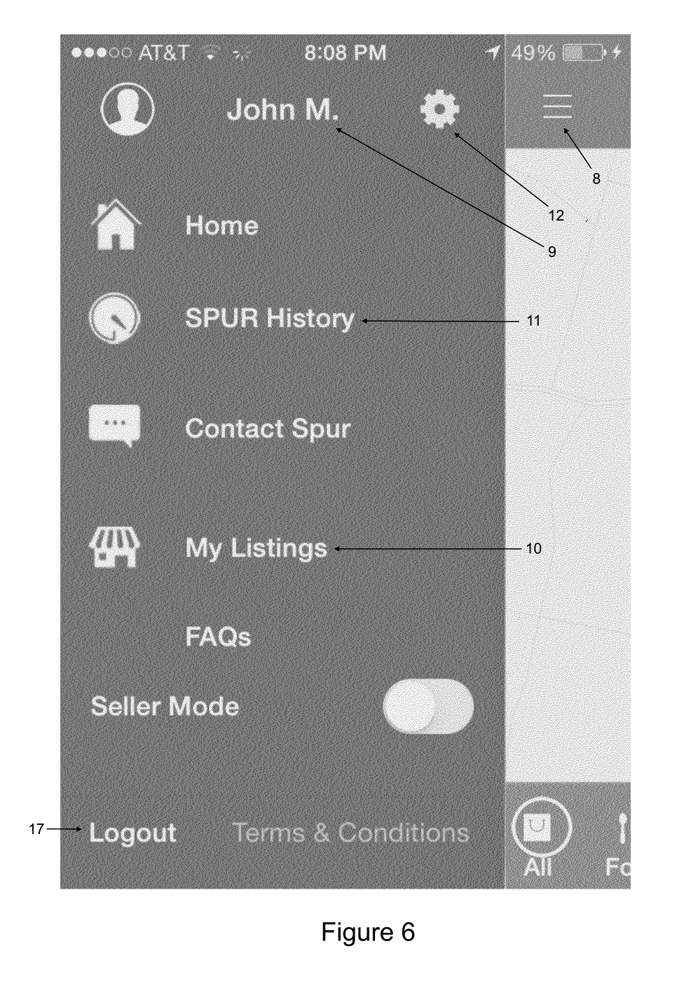

FIG. 6 shows the SPUR system set for seller mode. One of the advantages of the SPUR system is that both buyers and sellers use the same system. Any given user can operate as both buyer and seller, as well. As used herein, a SPUR is defined as a customer inquiry for the seller's goods or services. For example, an electrician performing a SPUR at a client's residence can change his settings to buyer mode and locate a mobile pizza delivery that will provide food at the location of the electrical work. The electrician can then change his device back to seller mode, and check the listing of open SPURS that he can choose to fill.

As seen in FIG. 6 the settings menu (8) at the top left of the screen is open to the user (9) John Oneman. John Oneman's listings are shown at (10). Listings can include any category a buyer could select in buyer mode that the seller offers. The seller's SPUR history is shown at (11), where the completed SPUR's are listed. His individual settings are shown at (12). Any feedback from prior customers from previous SPUR's can be viewed by selecting (13). Toggle (14) is selected to log out from the SPUR system. Toggle (17) allows the user to log out of the SPUR system.

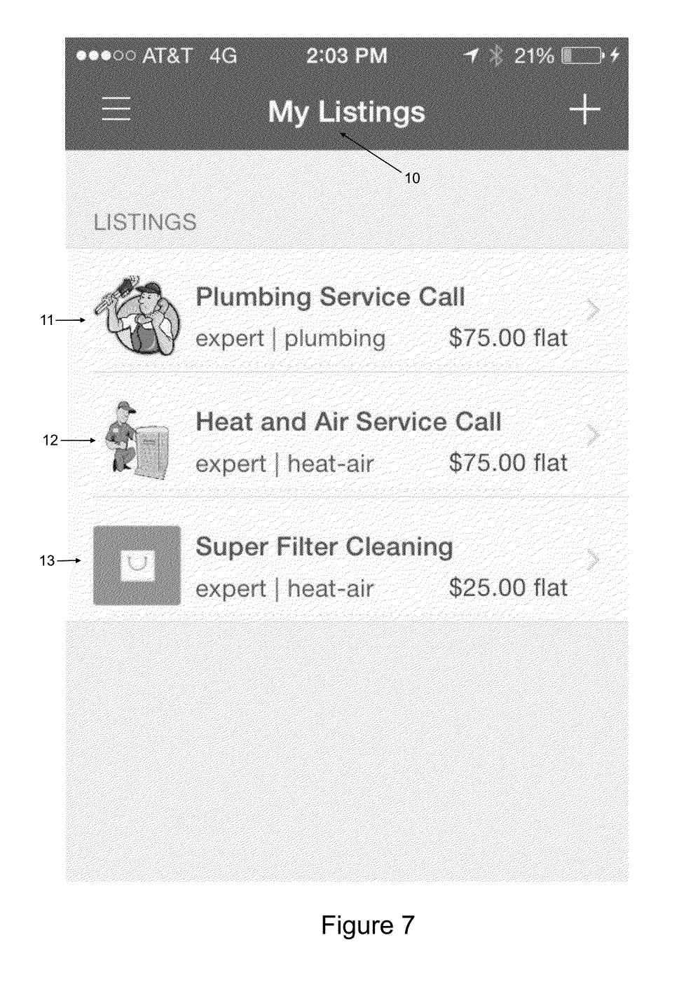

FIG. 7 shows the user's listings (10) open, exposing the user's available goods and services. As seen in FIG. 7, the user is offering plumber services (11) at $55/hour, gooey bread (12) at $5 flat fee, and a Bugatti automobile (13) at $50,000 flat fee. It must be noted that when in buyer mode, a buyer will see that user John Oneman is offering services, and goods as seen in element (4) of FIG. 1. Likewise the screen will also show John Oneman's location in real time as (2) of FIG. 1.

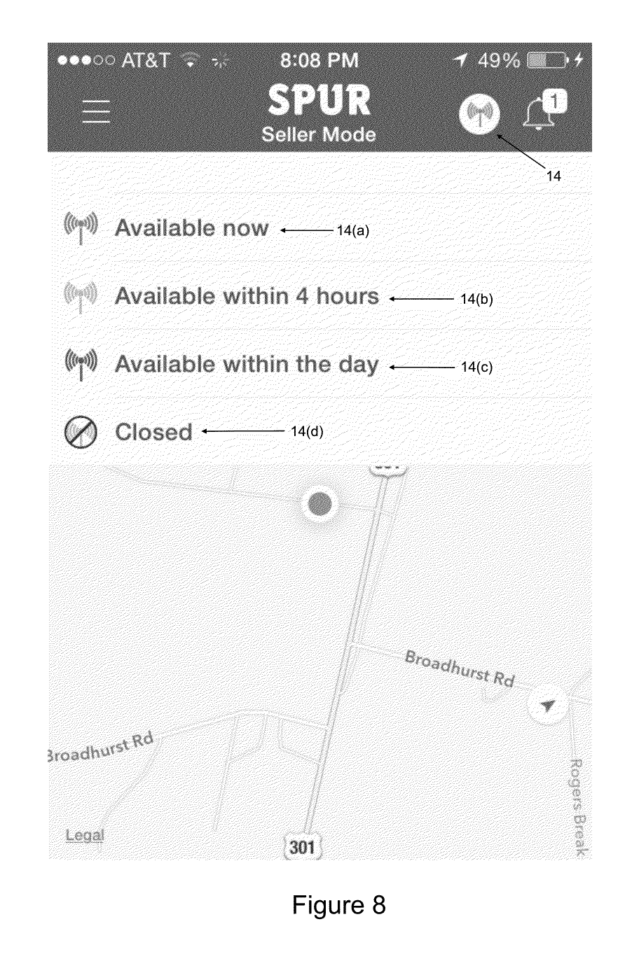

FIG. 8 shows the user's screen when the beacon icon (14) is activated. In this mode, the seller can receive SPUR requests from customers as well as alert customers to his real time status.

In order to set the seller's real time status, the seller selects the color of the beacon according to availability. The icon (14) is color coded according to a given user's availability. The color of the icon (14) appears the same on the sellers and buyers mode. For instance, if a customer in the buyer mode searches for mobile plumbers, the customer will see the color beacon for each mobile plumber that is located in response to the customer's search. When icon (14) appears as red, the user is open and is receiving inquiries from buyers. A green beacon indicates the seller is available immediately, as at (14a). A yellow status beacon (14b) means the seller is available within four hours. Red (14c) means the seller is available sometime that day. When the seller closes business for the day, he sets the status beacon as shown by element (14d). It is understood that these settings are by example only and the invention is not to be so limited.

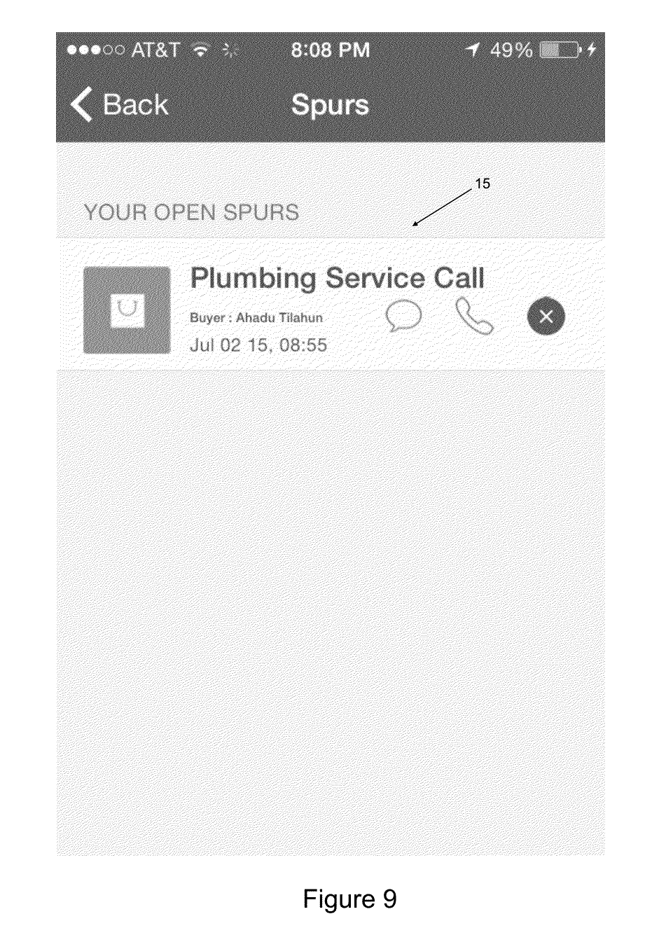

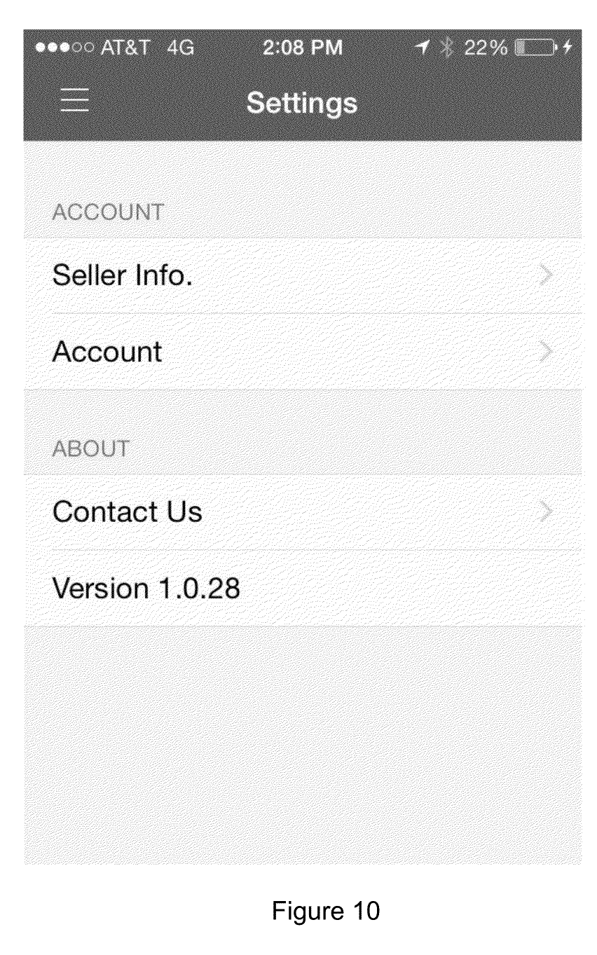

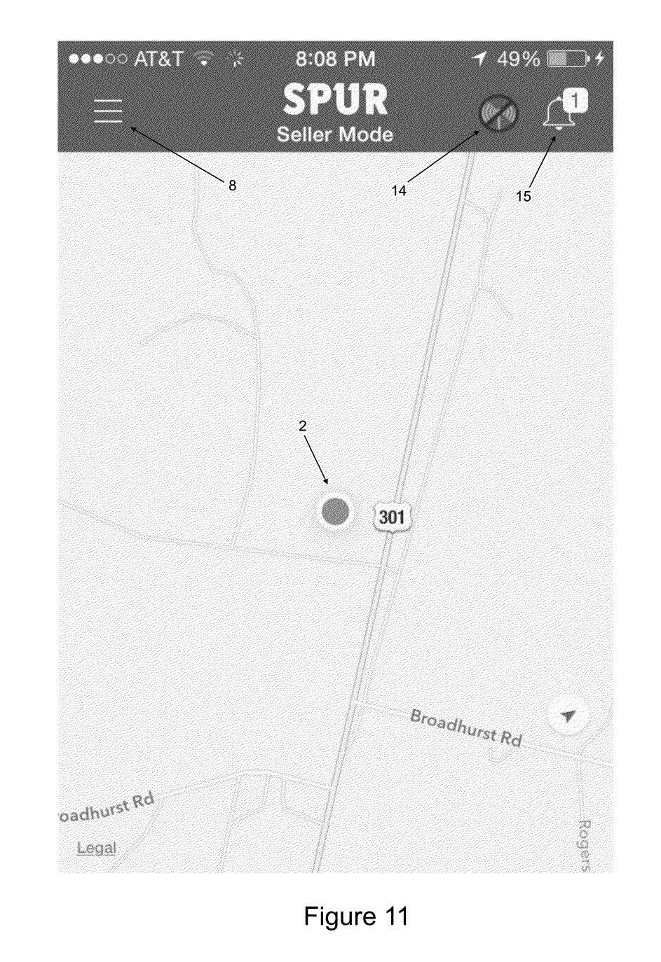

FIG. 9 shows any open SPURS (15) the seller may have in real time, in this case none. An open SPUR represents a customer inquiry that is unanswered or unscheduled, or unperformed. Once a customer has received a service or been sold goods, the SPUR is closed and it will not appear on the user's screen, as in FIG. 9. In seller mode the seller can view the status of a SPUR inquiry as all inquiries (16), unconfirmed (15a), confirmed (15b), or when the customer has simply been contacted (15c). To do so, as seen in FIG. 11 the seller selects to view all SPURS (16), or selects to view any SPUR status subset by selecting the toggle for unconfirmed (16a), confirmed (16b), or contacted (15c). FIG. 10 shows a logout screen for the SPUR system. As can be seen, the user can store information such as account, billing, terms and conditions, or any values suitable for the particular circumstances.

1. A system providing an open marketplace for mobile goods and services brought directly to a user on demand comprising:
(a) a first computer device with a display including a first storage media storing a first and second set of executable computer instructions programmed on the first storage media;
(b) a second computer device with a display including a second storage media storing the first and second second executable set of computer instructions programmed on the second storage media;
(c) wherein the first and second executable set of computer instructions provide an open marketplace whereby a vendor offering goods and services, can interface with a buyer on a real time basis;
wherein any user of the system can act as both a buyer and seller, on a real time basis with other users of the system.

2. The system of claim 2 wherein the first computer device is selected from the set consisting of smart phones, pad devices, or lap-top computers.

3. The system of claim 2 wherein the second computer device is selected from the set consisting of smart phones, pad devices, or lap-top computers.

4. The system of claim 1 wherein users of the system can advertise goods and services including availability of the goods and services on a real time basis.

5. The system of claim 4 the system includes color coded icons indicating the relative availability of a vendor.

6. The system of claim 1 wherein users of the system can advertise goods and services including location of the goods and services on a real time basis.

7. The system of claim 2 wherein the user can toggle between buyer mode and seller mode at anytime using a toggle switch.

8. The system of claim 7 wherein the first set of executable computer instructions operates the computer device in buyer mode and the second set of executable computer instructions operates the computer device in vendor mode.

8. The system of claim 2 wherein buyers can search for and immediately schedule a mobile service or product on demand.

9. A computer device storing computer executable instructions, including a display, for providing a real time interactive interface between mobile vendors of mobile goods and services and buyers for goods and services, on demand, comprising
(a) a first computer device including a first storage media storing a first executable set of computer instructions programmed on the first storage media, wherein the first set of executable instructions allows a mobile vendor to offer goods or services to a buyer on a real time basis;
(b) the first computer device including a first storage media storing a second executable set of computer instructions programmed on the first storage media wherein the second set of executable instructions allows a buyer to schedule the purchase of goods or services from a mobile vendor on a real time basis
(c) a switch whereby a user of the first computer device can alternate the display between a vendor mode or a customer mode.

10. The computer device of claim 9 wherein users of the system in vendor mode can advertise goods and services including availability of the goods and services on a real time basis.

11. The computer device of claim 10 wherein the computer device displays color coded icons indicating the relative availability of a vendor.

12. The computer device of claim 10 wherein users of the computer device in vendor mode can advertise goods and services while displaying a location of the goods and services on a real time basis.

13. A method of interfacing vendors with customers on a real time basis with a single system comprising
(a) storing first and second computer executable instructions on a first computer device, for providing an on demand real time interactive interface between mobile vendors of goods and services and buyers of goods and services,
(b) selecting either a vendor mode or a buyer mode of the computer device;
(1) executing a first executable set of computer instructions programmed on the first computer device to enable a mobile vendor to offer goods or services to a buyer on a real time basis, when in a vendor mode;
(2) offering goods or services to a customer on a real time basis, when in vendor mode;
(3) executing a second executable set of computer instructions programmed on the first computer device to enable a buyer to schedule receipt of goods or services from a mobile vendor on a real time basis when in a buyer mode;
(4) scheduling receipt of goods or services from a mobile vendor on a real time basis when in a buyer mode;
(c) wherein a user in vendor mode interfaces with a buyer in buyer mode through a single system.

14. The method of claim 13 including displaying the availability of goods and services on a real time basis.

15. The method of claim 13 including displaying color coded icons indicating the relative availability of a vendor.

16. The method of claim 13 including displaying the location of the goods and services on a real time basis.
